(19) United States
(12) Patent Application Publication
(10) Pub. No.: US 2026/0291801 A1
(43) Pub. Date: Sep. 24, 2026

(54) SERVING MULTIPLE WIRELESS COMMUNICATION DEVICES USING ACCESS NODE WITH REFLECTIVE INTELLIGENT SURFACE

(71) Applicant: Sony Group Corporation, Tokyo (JP)

(72) Inventors: Fredrik RUSEK, Eslöv (SE); Erik BENGTSSON, Eslöv (SE); Jose FLORDELIS, Lund (SE)

(21) Appl. No.: 19/168,401

(22) PCT Filed: Mar. 27, 2024
(86) PCT No.: PCT/EP2024/058381

§ 371 Date: Sep. 24, 2025

(30) Foreign Application Priority Data
Apr. 14, 2023 (SE) 2350449-1

(51) Int. Cl. H04L 27/36

(52) U.S. Cl. CPC H04L 27/36

(57) ABSTRACT

Various disclosed techniques pertain to serving multiple wireless communication devices using partitions of a reflective intelligent surface. Various disclosed techniques pertain to providing, to the wireless communication device, indications of transmission probabilities of symbol samples of an amplitude-phase shift keying, A-PSK, modulation alphabet.

### TECHNICAL FIELD

Various examples of the disclosure pertain to communication from an access node to a wireless communication device using amplitude phase shift keying modulation. According to various examples, the access node includes a reconfigurable intelligent surface that is fed by a single-chain radio-frequency source.

### BACKGROUND

Li, Qingchao, et al. “Reconfigurable Intelligent Surface Aided Amplitude- and Phase-Modulated Downlink Transmission.” arXiv preprint arXiv:2301.09717 (2023) describes methods of operating an access node (AN), in particular a transmitting node, of a communication network. The AN comprises a reconfigurable intelligent surface (RIS). The RIS may be fed by an unmodulated carrier from a single RF signal generator. The AN may rely on a single RF chain and the information may be transmitted by appropriately configuring the reflection coefficients of antenna elements of the RIS. In particular, the RIS may comprise an array of many antenna elements and the reflection coefficients may be configured by applying individual phase shifts to the antenna elements. The unmodulated carrier from the RF signal generator may then be reflected towards a specific direction, i.e., towards a specific wireless communication device (e.g., a user equipment, UE), with a beamforming gain that depends on the phase shifts. An amplitude phase shift keying (A-PSK) modulation is disclosed.

It has been observed that it is difficult to serve multiple wireless communication devices using the disclosed techniques.

### SUMMARY

A need exists for improving transmission from an AN to multiple UEs.

A method performed by AN of a communication network is disclosed. The method includes providing, to a wireless communication device of the communication network that is being served by the AN, one or more messages. The one or more messages are associated with an amplitude and phase-shift-keying, A-PSK, modulation used by the AN for transmitting. The one or more messages are indicative of an alphabet of the A-PSK modulation and further indicative of one or more transmission probabilities of one or more symbol samples of the alphabet.

An AN is disclosed that includes control circuitry configured to perform such method.

A method performed by a wireless communication device of a communication network is disclosed. The wireless communication device is served by an AN of the communication network. The method includes obtaining, from the AN, one or more messages. The one or more messages are associated with an amplitude and phase-shift-keying, A-PSK, modulation. The A-PSK modulation is used by the AN for transmitting. The one or more messages are indicative of an alphabet of the A-PSK modulation. The one or more messages are further indicative of one or more transmission probabilities of one or more symbol samples of the alphabet. The method also includes configuring a demodulation process for received symbols of the A-PSK modulation in accordance with the alphabet and the one or more transmission probabilities.

A wireless communication device is disclosed that includes control circuitry configured to perform such method.

A method performed by an AN of a communication network is disclosed. The AN includes a RIS. The RIS includes a plurality of antenna elements for applying an amplitude and phase-shift-keying, A-PSK, modulation to an incident carrier signal. The AN serves multiple wireless communication devices of the communication network. The method includes obtaining a set of symbols of the A-PSK modulation. Different symbols of the set of symbols are associated with different ones of the multiple wireless communication devices. The method also includes, responsive to obtaining the set of symbols, determining an allocation of each symbol of the set of symbols to one or more partitions of the plurality of antenna elements. The method further includes, based on the allocation, determining phase-shift values for each antenna element of the plurality of antenna elements.

An AN is disclosed that includes control circuitry configured to perform such method.

It is to be understood that the features mentioned above and those yet to be explained below may be used not only in the respective combinations indicated, but also in other combinations or in isolation without departing from the scope of the disclosure.

### BRIEF DESCRIPTION OF THE DRAWINGS

FIG. 1 schematically illustrates a communication network including an AN and multiple UEs being served by the AN, the AN including a RIS according to various examples.

FIG. 2 is a constellation diagram of an example alphabet of an A-PSK modulation employed by the AN for communicating with UEs.

FIG. 3 includes multiple constellation diagrams of different alphabets of an A-PSK modulation according to various examples.

FIG. 4 illustrates the capacity of a lower-priority UE for different alphabets according to various examples.

FIG. 5 is a flowchart of a method according to various examples.

FIG. 6 is a signaling diagram according to various examples.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which coact with one another to perform operation(s) disclosed herein. In addition, any one or more of the electrical devices may be configured to execute a program code that is embodied in a nontransitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between nodes. A wireless communication system includes a transmitter node and one or more receiver nodes. In some examples, the wireless communication system can be implemented by a wireless communication network, e.g., a radio-access network (RAN) of a Third Generation Partnership Project (3GPP)-specified cellular network (NW). In such case, the transmitter node can be implemented by an AN, in particular, a base station (BS), of the RAN, and the one or more receiver nodes can be implemented by wireless communication devices (also referred to as user equipment, UE). It would also be possible that the transmitter node is implemented by a UE and the one or more receiver nodes are implemented by an AN and/or further UEs. Hereinafter, for the sake of simplicity, various examples will be described with respect to an example implementation of the transmitter node by one or more ANs and the one or more receiver node by UEs—i.e., to downlink (DL) communication; but the respective techniques can be applied to other scenarios.

Hereinafter, techniques that employ a RIS-based AN are disclosed. The RIS can be implemented as a parabolic antenna. An RF source is provided that transmits the RF signal to the parabolic antenna. The parabolic antenna includes an array of antenna elements. The distance between the feeder and the antenna is small and in the near-field of the electromagnetic waves. The antenna elements can be quickly switched, e.g., using a barium-strontium-titanate technology.

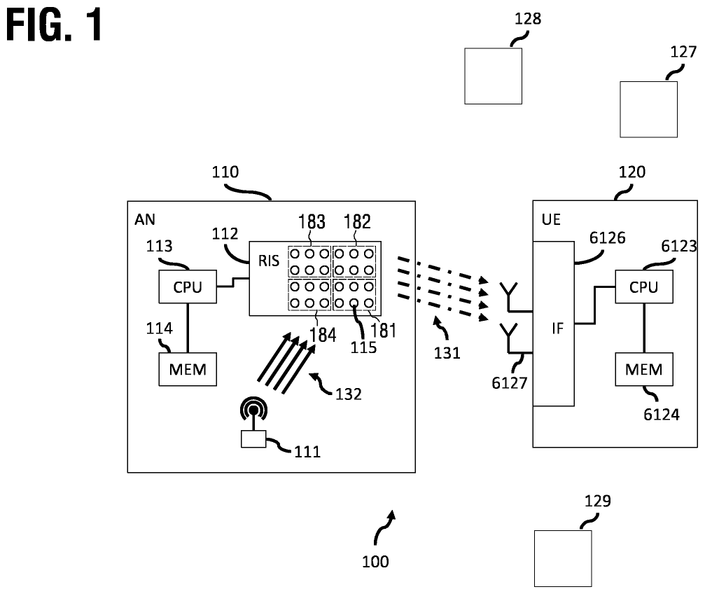

FIG. 1 illustrates a communication network 100 comprising an AN 110 and a UE 120. The communication network 100 also includes further UEs 127-129.

The AN 110 comprises an RF signal generator 111, a RIS 112 and control circuitry for controlling the RIS 112 and/or the RF signal generator 111. The RF signal generator 111 is fed by a single RF chain, i.e., using a single digital-to-analog converter per polarization. The energy for the signal 131 to be transmitted from the AN 110 to the UE 120 is provided by the RF signal generator 111 transmitting an unmodulated carrier signal 132. Thus, there is a radio transmission within the AN 110, from the RF signal generator 111 to the RIS 112. The RF signal generator 111 is typically arranged in the electromagnetic near field of the RIS 112.

The control circuitry may be implemented by a processor 113 and a non-volatile memory 114. The processor 113 can load program code that is stored in the memory 114. The processor 113 can then execute the program code. Executing the program code causes the processor to perform techniques as described herein. The UE 120 includes control circuitry that is implemented by a processor 6123 and a non-volatile memory 6124. The control circuitry 6123, 6124 may control an interface 6126 connected to antennas 6127. The processor 6123 can load program code that is stored in the memory 6124. The processor 6123 can execute the program code.

Executing the program code causes the processor 6123 to perform techniques as described herein.

While details of the UEs 127-129 are not shown in FIG. 1, these UEs 127-129 can be configured similarly to the UE 120.

In some examples, the AN 110 may not include the RF signal generator 111 itself, but the unmodulated carrier 132 used by the AN 110 may be provided by an external source. Control circuitry 113, 114 of the AN 110 may control antenna elements 115 of the RIS 112 to generate the signal 131 towards the UE 120. The signal is an A-PSK modulated signal. This is explained next.

The RIS is partitioned into V partitions; for example, in FIG. 1 V=4 for the partitions 181-184. Let the channel between partition v and the UE be denoted by hᵥ (more generally, let h_{v,m} denote the channel from partition v to UE m). Each partition includes multiple antenna elements 115. Each partition is configured with beamforming coefficients cᵥ=pᵥ^{e}^{^{iφ}}aᵥ where pᵥ(k)=e^{-i∠h}^{ᵥ}^{(k)} (where pᵥ(k) is the k:th element of pᵥ, pᵥ being the information-independent part of the beamforming coefficients, and hᵥ(k) represents the channel between antenna element k of the v:th partition and the UE). The value P is an information-carrying phase value to be transmitted to the UE, and aᵥ∈{0, 1}. These parameters are thus defining the symbol of the A-PSK modulation.

Now, the control circuitry 113, 114 configures a₁=a₂= . . . = [symbol] =1 and [symbol] =a_{V}=0, for some value 1≤ [symbol] ≤V. At the UE 120, assuming |hᵥ(k)|=1, ∀k, v, the following signal is received

$$y = {C ℓ e}^{i ϕ} + n$$

where n is noise and C is a constant that absorbs transmit power, path losses, number of elements/panel, etc. This equation illustrates that the information is transferred to the UE via the two values φ and [symbol] =Σaᵥ.

The collection of admissible tuples {φ, [symbol] } constitutes the alphabet (also referred to as signal constellation) of the A-PSK modulation.

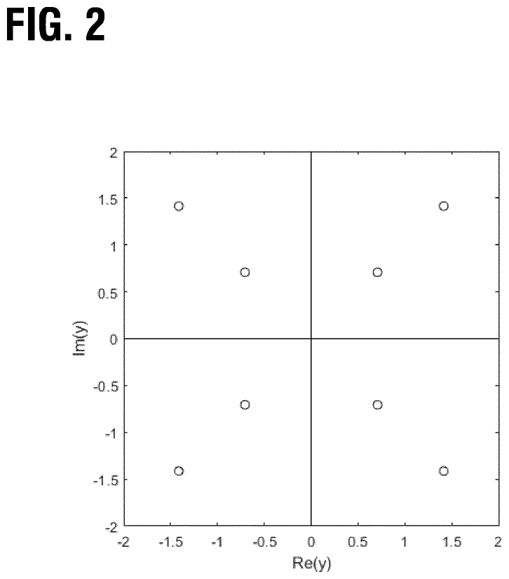

FIG. 2 is a constellation diagram of an example alphabet of the A-PSK modulation for V=2 (e.g., partitions 181, 182 being assigned to the UE 120 in FIG. 1) and φ∈{π/4, 3π/4, 5π/4, 7π/4}. In the constellation diagram, the distance of a given symbol sample of the alphabet from the origin denotes the amplitudes; and the angle illustrates the phase.

In FIG. 2, the four outermost points are generated from a₁=a₂=1, i.e., both partitions 181, 182 are active, and the four innermost are generated from a₁=1, a₂=0, i.e., the second partition—e.g., partition 182—is not active. Accordingly, depending on the particular symbol of the A-PSK modulation to be transmitted, it is required to determine an allocation of the symbol to one or more partitions of the antenna elements of the RIS. For symbols having higher amplitudes, more partitions are allocated to the transmission.

Various techniques are based on the finding that whenever aᵥ=0 for some v, said partitions are idle and not contributing to the transmission to a particular UE. These partitions that are, for a given symbol duration of the A-PSK modulation, not required for serving a first UE, can be meanwhile used for serving another, second UE.

Techniques to utilize partitions not used for a first UE for a second UE are disclosed herein. These techniques enable an increase in overall data throughput.

It is now assumed that, up to, V (i.e., up to the number of partitions) UEs are to be served (cf. FIG. 1, where V=4, i.e., there are at maximum four UEs 120, 127, 128, 129 served; the index m will be used for the UEs hereinafter; i.e., m V). Each UE is associated with a respective alphabet or constellation:

$${A}_{v} = \{ ( ϕ , b ) \vert ϕ ∈ Γ , b = 1 … {C}_{v} \}$$

where the set Γ is typically comprising a set of uniformly spaced phase values, C₁=V, and Cᵥ₊₁<Cᵥ.

Different UEs can have different alphabets. It would also be possible to use the same alphabet for different UEs. By using different alphabets, the throughput can be optimized.

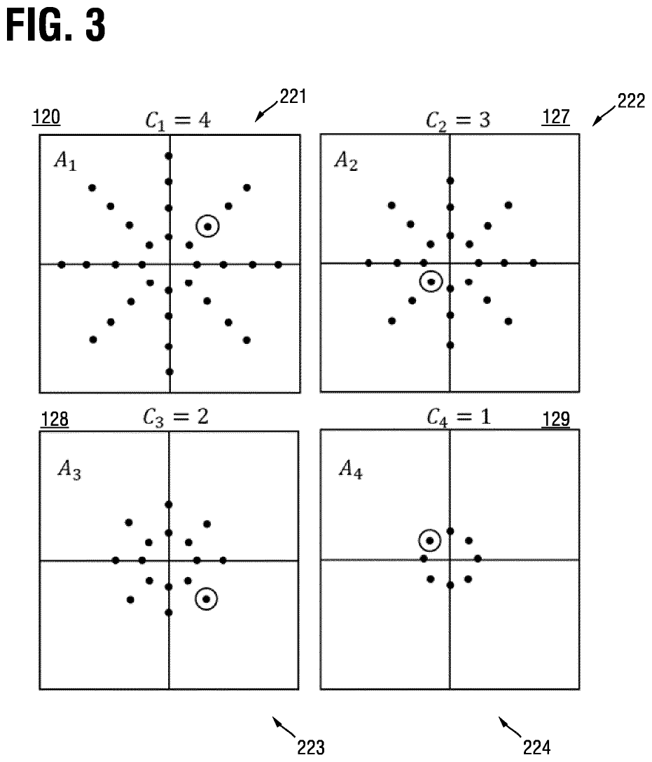

A scenario of using different alphabets 221-224 is illustrated in connection with FIG. 3.

Here, Γ={2πm/8, m=0 . . . 7} and V=4 C₁=4, C₂=3, C₃=2, and C₄=1.

The value Cᵥ specifies the number of different amplitudes in the alphabet Aᵥ.

For example, the alphabet 221 (denoted A₁) can be associated with the UE 120. For example, the alphabet 222 (denoted A₂) can be associated with the UE 127. For example, the alphabet 223 (denoted A₃) can be associated with the UE 128. For example, the alphabet 224 (denoted A₄) can be associated with the UE 129.

The alphabets 221-224 have different alphabet sizes. I.e., the number of symbol samples (the symbol samples are the positions in the constellation at which symbols can be transmitted, illustrated by the black dots in FIG. 3; symbol samples are also sometimes referred to as modulation symbols) is different. For instance, the number of symbol samples of the alphabet 221 is 32; while the number of symbol samples of the alphabets 224 is only 8. The higher number of symbol samples of the alphabet 221 is achieved by using higher transmission amplitudes. This means that there is a tendency that when communicating with the UE 120 a higher count of partitions of the RIS is required in order to convey a certain symbol to the UE; if compared to communicating with the UE 129. When communicating with the UE 129, only a single partition is required, because only a single amplitude level is included in the alphabet.

This already indicates that—due to the hardware-limited amount of partitions available at the RIS, depending on the particular symbol to be transmitted to the UE 120, it may or may not be the case that partitions are available for the remaining UEs 127-129. These constraints in the available partitions of the resulting strategy for allocating symbols to partitions are discussed below.

In every symbol interval, V data A-PSK symbols aᵥ ∈Aᵥ are formed. These can be expressed by the phase and amplitude, i.e., as aᵥ= [symbol] with [symbol] ∈{1, 2, 3, . . . , Cᵥ}.

$$\begin{matrix}K \\ K = max k such that {{\sum }_{p = 1}}^{k} {ℓ}_{p} \leq V\end{matrix} . \qquad ( 1 )$$

The V panels are configured as:

$$for 1 \leq k \leq K and 1 \leq {q}^{( k )} \leq {ℓ}_{k}$$

$${c}_{{Q}_{k} + {q}^{( k )}} = {p}_{{Q}_{k} + {q}^{( k )} , k} {e}^{i {ϕ}_{k}} where {Q}_{1} = 0 ,$$

$${Q}_{k} = {\sum }_{p = 1}^{k - 1} {ℓ}_{p} 2 \leq k \leq K , and$$

$${c}_{n} = 0 , n > {\sum }_{p = 1}^{K} {ℓ}_{p}$$

Also, the notation q^{(k)} means that k is a super index to q.

This finding is exemplified next. It is assumed that V=4 and alphabets 221-224 according to FIG. 3. Further, it is assumed that the four symbols aᵥ, 1≤v≤4 to be sent are the four high-lighted symbol samples in FIG. 3 (circles). Thus, [symbol] =2, [symbol] =1, [symbol] =2, [symbol] =1. These numbers are the “amplitude levels” of the transmitted symbols. The first symbol, a₁, associated with the UE 120 having highest priority, is always transmitted and requires [symbol] =2 partitions (cf. FIG. 1: partitions 181, 182). Thus (p_{v,k} is the complex conjugate of the channel h_{v,k}),

$${c}_{1} = {p}_{1 , 1} {e}^{i {ϕ}_{1}} , {c}_{2} = {p}_{2 , 1} {e}^{i {ϕ}_{1}} ( where {ϕ}_{1} = π / 4 ) .$$

This leaves V− [symbol] =2 idle partitions (cf. FIG. 1: partitions 183, 184). The next UE 127 to be served has [symbol] =1 so it needs a single partition, e.g., partition 183. Thus

$${c}_{3} = {p}_{3 , 2} {e}^{i {ϕ}_{2}} ( where {ϕ}_{2} = 5 π / 4 ) .$$

Thus, after allocating the symbol to be transmitted to the UE 128 to the partition 183, now V − [symbol] =1 partitions are left; this is partition 184 in FIG. 1. However, a₃ requires [symbol] =2 panels, so it cannot be accommodated. Thus,

$${c}_{4} = 0 .$$

Altogether, K=2 UEs are served which is given by equation (1) above by noting that

$${ℓ}_{1} + {ℓ}_{2} \leq V < {ℓ}_{1} + {ℓ}_{2} + {ℓ}_{3} .$$

When the partition-symbol/UE association process in this example terminates, the fourth partition 184 is left idle. This is a consequence of a built-in prioritization of UEs; the equations specify that UE k+1 can only be served if UE k is served. In the example illustrated above, it is not possible to serve UE 128 as it requires two partitions to transmit the correct symbol while only a single partition (the partition 184) was available after allocating the other partitions 181-183 to symbols to be transmitted to the higher-priority UEs 120, 127. Then, also UE 129 is not being served. However, UE 129 merely requires a single partition, because, [symbol] =1; so, it can in fact be accommodated. Therefore, it is possible to alter the partition-UE/symbol association so that UE 129 is served. Accordingly, in a variant of the example, the fourth partition 184 is configured to serve UE 129, i.e.,

$${c}_{4} = {p}_{4 , 4} {e}^{i {ϕ}_{4}} ( where {ϕ}_{4} = 3 π / 4 ) .$$

Next, based on such allocation between partitions and A-PSK symbols to be transmitted to multiple UEs, the capacity per UE is assessed. Consider UE k (i.e., any of the UEs 120, 127-129). In order to determine capacity for UE k, one needs an expression for the conditional probability P(yₖ|x), ∀x∈Aₖ, where yₖ is the received signal at UE k. We have

$$p ( {y}_{k} \vert x ) = \frac{1}{π {N}_{0}} [ {q}_{k} ( x ) exp ( - \frac{{\vert {y}_{k} - x \vert}^{2}}{{N}_{0}} ) + ( 1 - {q}_{k} ( x ) ) exp ( - \frac{{\vert {y}_{k} \vert}^{2}}{{N}_{0}} ) ]$$

where qₖ(x) is the probability that UE k is assigned partition given that UE k's data symbol is x. This quantity qₖ(x), in other words, is the transmission probability of the respective symbol sample of the alphabet. It is sometimes referred to as probability mass function (PMF).

The PMF reflects that is possible that a certain symbol to be transmitted to a lower-priority UE cannot be accommodated (e.g., as in FIG. 3, the symbol of the alphabet 223 to be transmitted to the UE 128). Generally, each UE uses knowledge of the PMF to correctly demodulate received symbols. The receiver may use maximum a posteriori (MAP) detection to associate a symbol x∈Aₖ to each received sample yₖ. That is, the receiver may perform the operation

$${\hat{y}}_{k} = {argmax}_{x ∈ {A}_{k}} p ( {y}_{k} \vert x ) p ( x ) ,$$

where typically p(x)=1/|Aₖ| and p(yₖ|x) is given earlier in this page. qₖ(x) is used by the receiver to compute p(yₖ|x). Details with respect to the PMF are described later.

To proceed further, the prior probabilities of the symbols in Aᵥ are considered. These are denoted pₖ(x). The capacity of UE k reads

$${R}_{k} = - E [ {log}_{2} p ( {y}_{k} ) + E [ {log}_{2} p ( {y}_{k} \vert x ) ] .$$

The unconditional probability density function P(yₖ) reads

$$p ( {y}_{k} ) = {\sum }_{x ∈ {A}_{k}} {p}_{k} ( x ) p ( {y}_{k} \vert x ) .$$

Provided that qₖ(x) is determined and that a prior distribution pₖ(x) is at hand, it is possible to evaluate Rₖ numerically, e.g., by Monte-Carlo computation. Further, it is noted that pₖ(x) can be optimized by the Arimoto-Blahut algorithm.

Next, pₖ(x) is calculated; this is done for the case initially discussed in connection with FIG. 3, i.e., if UE k cannot transmit, then UEs k+1, k+2, . . . cannot either (thus, UE 129 would be blocked from transmission, because UE 128 cannot transmit). This is done through, e.g., generating functions. Define the polynomials tₖ(z), k>1, as

$${t}_{k} ( z ) = {\prod }_{m = 1}^{k - 1} {\sum }_{j = 1}^{{c}_{m}} p ( {ℓ}_{m} = j ) {z}^{j} = {\sum }_{r = 1}^{{c}_{1} + … + {c}_{k - 1}} {t}_{rk} {z}^{r} .$$

The coefficient tᵣₖ in front of z^{r} gives the probability that exactly r panels are needed for transmission of UEs 1 . . . (k−1). Thus, the PMF qₖ(x) reads

$${q}_{k} ( x ) = {\sum }_{r = 0}^{V - \vert x \vert} {t}_{rk} . \qquad ( 2 )$$

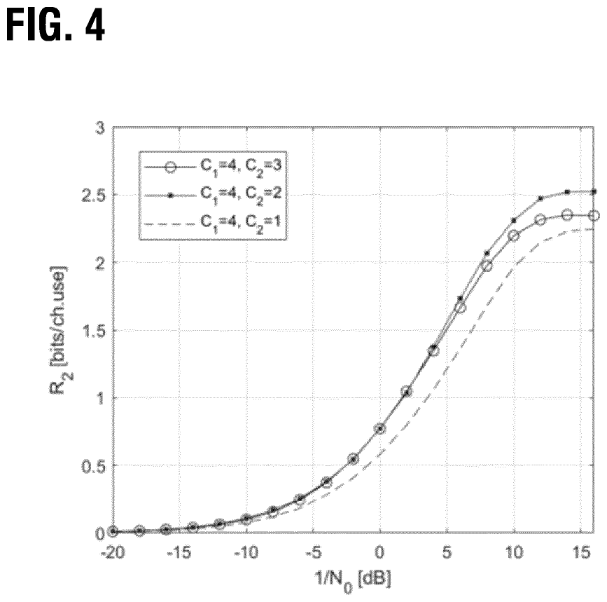

This is illustrated in FIG. 4. FIG. 4 shows the capacity R₂ for the UE 127. The UE 127 has a lower priority than the UE 120, but higher priority than the UEs 128, 129. This means that before the symbol to be transmitted to the UE 127 is allocated to partitions (if sufficient partitions are available), the symbol to be transmitted to the higher-priority UE 120 is allocated to one or more partitions of the RIS. It is possible that after allocating the symbol to be transmitted to the UE 120, no or at least an insufficient amount of partitions are available for transmitting the symbol to the UE 127. Whether or not a sufficient amount of partitions is available for transmitting the symbol to the UE 127 is impacted by the alphabet 222 used for the UE 127; since it includes higher-amplitude symbol samples ( [symbol] =2, [symbol] =3), it is possible that more than a single partition is required; that then reduces the F for these symbol samples. Higher-complexity alphabets including higher amplitudes tend to decrease the likelihood of being able to transmit a certain symbol. On the other hand, using lower-complexity alphabets decreases the achievable capacity as well; because fewer bits can be encoded per symbol. Thus, a sweet-spot of modulation complexity for throughput to each UE is expected. This sweet-spot can be seen in FIG. 4.

In the illustrated example of FIG. 4, again V=4 partitions are assumed, and the UE 120 is equipped with a constellation with C₁=V=4 amplitude levels. FIG. 4 shows the capacity results for a constellation A₂ formed from Γ={e^{i2πm/8}, m=0 . . . 7} and C₂ amplitude levels, where C₂ ranges from 1 to 3. As can be seen from FIG. 4, the most favorable value is C₂=2. That is, the largest constellation (highest complexity having most symbol samples at larger amplitudes) is not the best one to use. The underlying reason of this is that with C₂=3, the probability of transmission is too low, as explained above.

Note that with optimization of the prior probabilities, the larger alphabet is always superior (since it can convert itself into a smaller one by setting some probabilities to 0).

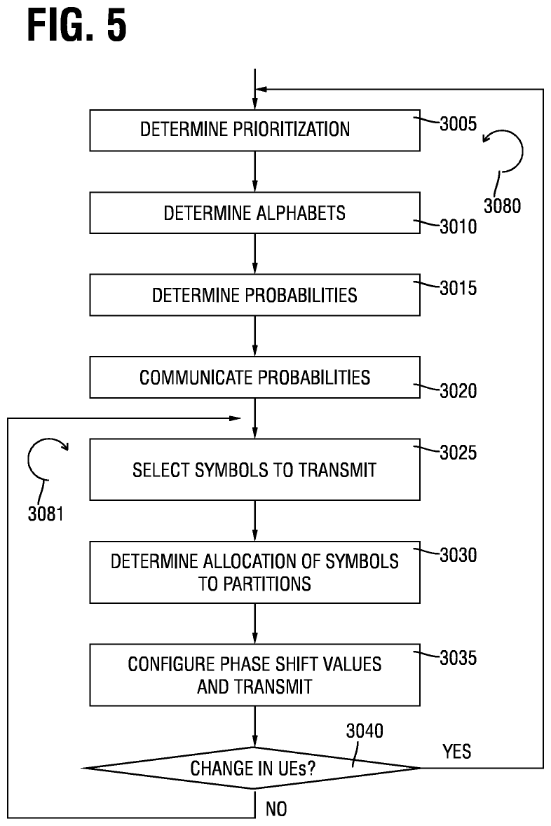

FIG. 5 is a flowchart of a method according to various examples. The method of FIG. 5 can be executed by an AN such as the AN 110. For instance, the method of FIG. 5 can be executed by the processor 113 upon loading program code from the memory 114 and upon executing that program code. The method of FIG. 5 generally pertains to transmitting data to a UE.

At box 3005, a prioritization of multiple UEs to be served is determined. Higher-priority UEs are more likely to be accommodated in each symbol interval. Higher-priority UEs tend to have a higher capacity than lower-priority UEs. Partitions of the RIS are first allocated to symbols to be transmitted to higher priority UEs.

Accordingly, it would be possible to determine the prioritization at box 3005 based on a quality-of-service requirement associated with data links associated with data to be transmitted to each served UE.

Details with respect to such prioritization have been discussed, e.g., in connection with FIG. 3. Here, the UE 120 has a higher priority than the other UEs 127-129. The UE 127 has a higher priority than the other UEs 128, 129; and so on.

In some examples, the prioritizations can be predefined and, accordingly, box 3005 is optional.

At box 3010, it is optionally possible to determine alphabets of the A-PSK modulation used to transmit data to the UEs.

In some examples, these alphabets can be predefined; as such, box 3010 is optional.

It would also be possible that the alphabets are determined, e.g., depending on the count of UEs to be served and/or depending on the prioritization level of different UEs. For instance, if a certain UE has a particularly high prioritization, a higher-complexity alphabet can be determined for that UE, in addition to preferentially allocating symbols of that UE to partitions of the RIS.

For instance, higher-prioritization UEs can use alphabets having higher complexity and using higher amplitudes; while such UEs having lower prioritization can use alphabets having lower complexity and using fewer amplitudes/smaller amplitudes. Such a scenario has been explained in connection with FIG. 3.

The alphabets have an impact on the capacity, e.g., as discussed in connection with FIG. 4. By determining the alphabets in accordance with prioritization, capacity can be maximized. Also, individual capacity of individual UEs can be maximized; as well as system-wide overall capacity.

As a general rule, different UEs can be associated with the same or different alphabets. It has been found that using different alphabets for different UEs increases the overall capacity, e.g., as previously discussed in connection with FIG. 4.

Next, at box 3015, the transmission probabilities of the symbol samples of the alphabet determined at box 3010 for each UE are determined. Respective techniques have been disclosed above in connection with Eq. 2. Such probabilities can be predetermined and stored in a lookup table.

Even if the alphabet of a first UE and of a second UE includes the same symbol samples (cf. FIG. 3 where all alphabets 221-224 include the symbol samples arranged in the inner circle [symbol] =1, close to the origin of the constellation plot), as a general rule, the transmission probabilities will differ for the different UEs. I.e., even if a symbol sample in the first alphabet has a certain phase and amplitude and that symbol sample having that phase and amplitude is also present in another alphabet, still due to these alphabets being used by UEs of different prioritization, different transmission probabilities will be observed. This is because hardware resources in terms of partitions are preferentially allocated to symbols being transmitted to higher-priority UEs. The probabilities, more generally, depend on the prioritization of the respective UE and the alphabet used for the respective UE.

Then, at box 3020, one or more message associated with the A-PSK modulation are provided to the UEs being served. The one or more messages provided to each of the multiple UEs being served are indicative of the respective alphabet of the A-PSK modulation used for that UE; as well as indicative of the transmission probabilities of the symbol samples of the respective alphabet. Such information can be conveyed more or less explicitly. For instance, if the UE is aware of its prioritization and the alphabets used by the higher-priority UEs, it may be able to deduce its transmission probabilities. Furthermore, symbol samples having the same amplitude, but different phases, may generally have the same transmission probability; so, it is not required to re-signal the transmission probabilities for all such symbol samples having different phases, but similar amplitudes.

For communicating such one or more message is associated with the A-PSK modulation above 3020, different techniques can be used. For instance, unicast messages can be provided for each of the UEs being served. For example, it would be possible to provide Radio Resource Control (RRC) control messages that include respective information elements.

Upon completion of box 3020, everything is set up for communicating data by using the A-PSK modulation. Accordingly, at box 3025, a set of symbols of the A-PSK modulation is obtained. The amount of partitions of the RIS required to transmit all symbols of the set does not exceed the amount of available partitions. On the other hand, the symbols and the set can be so selected as to utilize all or most partitions that are available.

Box 3025 can include selecting the symbols of the set from multiple transmission buffers associated with the multiple UEs. The selection is in accordance with the predefined prioritization of the UEs. The selection is made for each symbol interval. In particular, in connection with FIG. 3, multiple schemes have been disclosed that enable determination of which symbols can be accommodated on partitions of the RIS, by taking into account which partitions of the RIS have already been allocated to other, higher-priority UEs.

Thus, while the transmission buffers of the various UEs may have multiple symbols buffered for transmission, it is possible that symbols are not selected from all transmission buffers of all UEs, but rather preferentially from the higher-priority UEs, depending on the availability of partitions in the respective symbol interval.

A non-selected symbol of a given UE may be left in the respective transmit buffer; for later transmission, in a subsequent symbol interval. In such a scenario, lower priority UEs wait until being delivered with a respective symbol. Alternatively, a non-selected symbol of a given UE may be deleted from the transmit buffer (and not transmitted later on). The symbol may be dropped. This can be modeled by an erasure channel, from the perspective of the receiver. A code (i.e., structured redundancy) can be applied to the source data so that all source data can be recovered at the receiver, despite some potentially missing symbols at the receiver.

Once it has been determined which symbols to transmit, these symbols are then allocated to partitions of the RIS, i.e., to the partitions formed by the antenna elements of the RIS. This occurs at box 3030.

Then, phase shift values for each antenna element of the plurality of antenna elements are determined to deliver data encoded by the symbol to the respective UE (for which the symbol is to be delivered during the current symbol interval) using the phase shift defined by the respective symbol in accordance with the A-PSK modulation. This happens at box 3035. Conventional beamforming techniques can be employed to determine the phase precoding at each antenna element of the partitions allocated to the respective symbol to be delivered to a particular UE.

Next, at optional box 3040, it can be determined whether a change in the UEs being served has occurred. For instance, a new UE to be served may have been connected to the AN. It would be possible that a UE previously served has disconnected from the AN. If there is no change in the UEs being served, then the probabilities previously determined and communicated at boxes 3015, 3020 are still applicable and in a further iteration 3081 the boxes 3025, 3030, 3035 are reexecuted, for the next symbol interval. Thus, the iteration 3081 pertains to subsequent symbol intervals of the A-PSK modulation. This means that at each symbol interval it is determined anew whether a symbol in a transmit buffer associated with a certain UE is to be delivered to that UE.

At some point, it may be detected, at box 3040, that the change in the UE serving situation has happened. In such case, it is possible to execute a further iteration 3080 of boxes 3005 and following. I.e., new probabilities can be eventually determined at box 3015 and communicated at box 3020. An update of the transmission probabilities can be provided to all UEs being served. These updates are triggered by changes in the count of UEs being served by the AN.

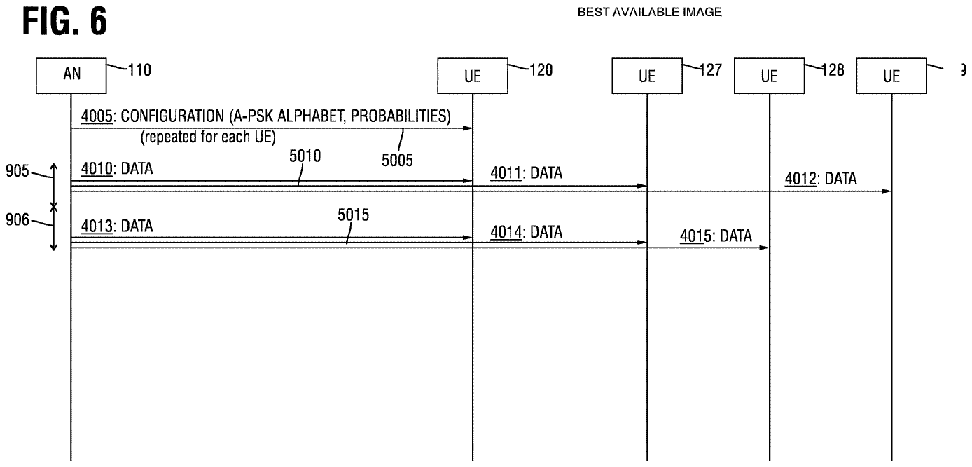

FIG. 6 is a signaling diagram of communication between the AN 110 and the UEs 120, 127-129.

At 4005, the AN 110 provides one or more configuration messages, e.g., an RRC configuration message including multiple information elements, to each of the UEs 120, 127-129 (in FIG. 6 only a single message to the UE 120 is shown for the sake of simplicity; but similar messages 4005 are also transmitted to the other UEs 127-129).

In another scenario, the AN 110 provides, to each UE 120, 127-129, a list of configurations, i.e., a list where each entry contains an alphabet and the associated one or more transmission probabilities. Then, later, an index is sent, to each UE 120, 127-129, to communicate which of the entries of the list the UE shall use for a certain transmission or set of transmissions. For example, this index can be provided with a downlink control indicator (DCI). A default configuration can also be configured. The default configuration is used, for example, to receive DCIs; it can also be used to receive transmissions when if no other configuration for the transmissions is indicated by the AN 110.

The message 4005 provided to the UE 120 is indicative of the alphabet of the A-PSK modulation used for that UE 120; as well as one or more transmission probabilities of symbol samples of that alphabet.

For instance, a transmission probability can be indicated for each amplitude level of symbol samples included in the respective alphabet. Since each UE 120, 127-129 potentially has a different alphabet and also has different transmission probabilities (depending on the prioritization), the respective configuration message 4005 needs to be individually communicated to each of the UEs 120, 127-129 including the respective relevant information. 5005 corresponds to box 3020 in a method of FIG. 5.

The UEs 120, 127-129 can then configure the demodulation process based on the respective information, e.g., based on the A-PSK alphabet as well as the probabilities of the symbol samples of the alphabet. This is required for being able to correctly demodulate respectively send and receive signals; as well as to be able to deal with symbol interval during which there is no respective symbol to be transmitted to the UE in the set of symbols that are allocated to partitions of the RIS of the AN 110.

It is possible that not all UEs are capable of configuring dynamically the demodulation process based on the probabilities of the symbol samples of the alphabet. Accordingly, it would be possible that, preceding 5005, the UEs 120, 127-129 provide respective capability information to the AN 110.

Then, at the symbol interval 905, A-PSK symbols are transmitted to the UE 120, to the UE 127 and to the UE 129 (but not to the UE 128). The symbol transmitted to the UE 120 encodes data 4010; the symbol transmitted to the UE 127 encodes data 4011; and the symbol transmitted to the UE 129 encodes data 4012.

Such a scenario in which the highest-priority UE 120, the second-highest-priority UE 127 as well as the lowest priority UE 129 are being delivered with data has been previously discussed for illustration in connection with FIG. 3.

5010 corresponds to box 3035.

Then, in the next symbol interval 906 (corresponding to a further iteration 3081; cf. FIG. 5), at 5015, data 4013 is transmitted using a respective A-PSK symbol to the UE 120; data 4014 is transmitted using a respective symbol to the UE 127; and data 4015 is transmitted to the UE 128 using a respective symbol. In this symbol interval 906, the lowest-priority UE 129 it is not receiving data. FIG. 6 illustrates that from symbol interval to symbol interval, different UEs can be excluded from transmission at the AN, due to lack of availability of partitions of the RIS. This makes it necessary to signal the transmission probabilities at 5005 to each UE so that the UEs can appropriately deal with such blanked symbol intervals. The UEs can accordingly decide, for each of sequential symbol intervals—in the illustrated example, the symbol intervals 905, 906, —whether any received signals pertain to a symbol for the wireless communication device or to noise/symbols directed to other UEs.

Summarizing, at least the following EXAMPLES have been disclosed.

Example 1. A method performed by an access node, AN, (110) of a communication network (100), the method comprising:
providing (3020), to a wireless communication device (120, 127, 128, 129) of the communication network (100) that is being served by the AN (110), one or more messages (4005) associated with an amplitude and phase-shift-keying, A-PSK, modulation used by the AN (110) for transmitting,
wherein the one or more messages (4005) are indicative of an alphabet (221, 222, 223, 224) of the A-PSK modulation and further indicative of one or more transmission probabilities of one or more symbol samples of the alphabet (221, 222, 223, 224).

Example 2. The method of example 1, further comprising:
providing, to the wireless communication devices (120, 127, 128, 129), one or more updates of the one or more transmission probabilities.

Example 3. The method of example 2,
wherein the one or more updates are triggered by changes in a count of wireless communication devices (120, 127, 128, 129) being served by the AN (110).

Example 4. The method of any one of the preceding examples, further comprising:
providing, to a further wireless communication of the communication network that is being served by the AN, one or more further messages associated with the A-PSK modulation used by the AN for transmitting,
wherein the one or more further messages are indicative of a further alphabet of the APSK modulation and further indicative of one or more further transmission probabilities of one or more further symbol samples of the further alphabet
wherein the alphabet (221, 222, 223, 224) and the further alphabet (221, 222, 223, 224) are different.

Example 5. The method of example 4,
wherein at least one symbol sample of the alphabet (221, 222, 223, 224) has a same phase and amplitude as at least one further symbol sample of the further alphabet (221, 222, 223, 224),
wherein the at least one symbol sample and the at least one further symbol sample have different transmission probabilities.

Example 6. A method performed by an access node, AN, of a communication network, the AN comprising a reconfigurable intelligent surface, RIS, comprising a plurality of antenna elements for applying an amplitude and phase-shift-keying, A-PSK, modulation to an incident carrier signal, the AN serving multiple wireless communication devices of the communication network,
wherein the method comprising:
   obtaining (3025) a set of symbols of the A-PSK modulation, different symbols of the set of symbols being associated with different ones of the multiple wireless communication devices,
   responsive to obtaining the set of symbols, determining (3030) an allocation of each symbol of the set of symbols to one or more partitions of the plurality of antenna elements,
   based on the allocation, determining (3035) phase-shift values for each antenna element of the plurality of antenna elements.

Example 7. The method of example 6,
wherein said obtaining the set of symbols comprises selecting the symbols of the set of symbols from multiple transmission buffers associated with the multiple wireless communication devices,
said selecting being in accordance with a predefined prioritization of the multiple wireless communication devices.

Example 8. The method of example 6 or 7, further comprising:
determining, for each of the multiple wireless communication devices (120, 127, 128, 129), a respective alphabet (221, 222, 223, 224) of the A-PSK modulation, different ones of the multiple wireless communication devices (120, 127, 128, 129) being associated with different alphabets (221, 222, 223, 224).

Example 9. The method of example 8,
wherein the alphabets (221, 222, 223, 224) are determined in accordance with a predefined prioritization of the multiple wireless communication devices (120, 127, 128, 129).

Example 10. The method of any one of examples 6 to 9, further comprising:
for each of the multiple wireless communication devices (120, 127, 128, 129), determining one or more transmission probabilities of one or more symbol samples of the respective alphabet (221, 222, 223, 224
providing, to each of the multiple wireless communication devices (120, 127, 128, 129), one or more respective one or more messages (4005) associated with the A-PSK modulation,
wherein the respective one or more messages provided to each of the multiple wireless communication devices are indicative of the respective alphabet of the A-PSK modulation associated with the respective wireless communication device (120, 127, 128, 129) and further indicative of the respective one or more transmission probabilities of one or more symbol samples of the respective alphabet (221, 222, 223, 224).

Although the disclosure has been shown and described with respect to certain preferred embodiments, equivalents and modifications will occur to others skilled in the art upon the reading and understanding of the specification. The present disclosure includes all such equivalents and modifications and is limited only by the scope of the appended claims.

1. A method performed by an access node of a communication network, the method comprising:
providing, to a wireless communication device of the communication network that is being served by the access node, one or more messages associated with an amplitude and phase-shift-keying (A-PSK) modulation used by the access node for transmitting,
wherein the one or more messages are indicative of an alphabet of the A-PSK modulation and further indicative of one or more transmission probabilities of one or more symbol samples of the alphabet.

2. The method of claim 1, further comprising:
providing, to the wireless communication devices, one or more updates of the one or more transmission probabilities.

3. The method of claim 2,
wherein the one or more updates are triggered by changes in a count of wireless communication devices being served by the access node.

4. The method of claim 1, further comprising:
providing, to a further wireless communication of the communication network that is being served by the access node, one or more further messages associated with the A-PSK modulation used by the access node for transmitting,
wherein the one or more further messages are indicative of a further alphabet of the A-PSK modulation and further indicative of one or more further transmission probabilities of one or more further symbol samples of the further alphabet.

5. The method of claim 4,
wherein the alphabet and the further alphabet are different.

6. The method of claim 5,
wherein at least one symbol sample of the alphabet has a same phase and amplitude as at least one further symbol sample of the further alphabet
wherein the at least one symbol sample and the at least one further symbol sample have different transmission probabilities.

7. A method performed by a wireless communication device of a communication network, the wireless communication device being served by an access node, access node, of the communication network, the method comprising:
obtaining, from the access node, one or more messages associated with an amplitude and phase-shift-keying (A-PSK) modulation used by the access node for transmitting, the one or more messages being indicative of an alphabet of the A-PSK modulation and further indicative of one or more transmission probabilities of one or more symbol samples of the alphabet, and
configuring a demodulation process for received symbols of the A-PSK modulation in accordance with the alphabet and the one or more transmission probabilities.

8. The method of claim 7, further comprising:
providing, to the access node, capability information indicative of the wireless communication device being capable to configure the demodulation process in accordance with the one or more transmission probabilities.

9. The method of claim 7, further comprising:
based on the one or more transmission probabilities, deciding, for each of sequential symbol intervals, whether received signals pertain to a symbol for the wireless communication device.

10. A method performed by an access node, access node of a communication network, the access node comprising a reconfigurable intelligent surface (RIS) comprising a plurality of antenna elements for applying an amplitude and phase-shift-keying (A-PSK) modulation to an incident carrier signal, the access node serving multiple wireless communication devices of the communication network,
wherein the method comprising:
obtaining a set of symbols of the A-PSK modulation, different symbols of the set of symbols being associated with different ones of the multiple wireless communication devices,
responsive to obtaining the set of symbols, determining an allocation of each symbol of the set of symbols to one or more partitions of the plurality of antenna elements,
based on the allocation, determining phase-shift values for each antenna element of the plurality of antenna elements.

11. The method of claim 10,
wherein said obtaining the set of symbols comprises selecting the symbols of the set of symbols from multiple transmission buffers associated with the multiple wireless communication devices,
said selecting being in accordance with a predefined prioritization of the multiple wireless communication devices.

12. The method of claim 11,
wherein any symbols not selected are dropped.

13. (canceled)

14. The method of claim 10, further comprising:
determining, for each of the multiple wireless communication devices, a respective alphabet of the A-PSK modulation, different ones of the multiple wireless communication devices being associated with different alphabets.

15. The method of claim 14,
wherein the alphabets are determined in accordance with a predefined prioritization of the multiple wireless communication devices.

16. The method of claim 15,
wherein alphabets comprising symbol samples having higher amplitudes are determined for those wireless communication devices having higher predefined prioritizations.

17. The method of claim 10, further comprising:
for each of the multiple wireless communication devices, determining one or more transmission probabilities of one or more symbol samples of the respective alphabet.

18. The method of claim 17,
wherein the one or more transmission probabilities are determined for each of the multiple wireless communication devices based on at least one of a respective predefined prioritization of the respective wireless communication device or a respective alphabet of the A-PSK modulation associated with the respective wireless communication device.

19. The method of claim 18, further comprising:
providing, to each of the multiple wireless communication devices, one or more respective one or more messages associated with the A-PSK modulation,
wherein the respective one or more messages provided to each of the multiple wireless communication devices are indicative of the respective alphabet of the A-PSK modulation associated with the respective wireless communication device and further indicative of the respective one or more transmission probabilities of one or more symbol samples of the respective alphabet.

20. An access node of a communication network, the access node comprising control circuitry configured to perform the method of claim 1.

21. A wireless communication device of a communication network, the wireless communication device being configured to be served by an access node of the communication network, the wireless communication device comprising control circuitry configured to perform the method claim 7.
